(19) United States
(12) Patent Application Publication
(10) Pub. No.: US 2015/0286973 A1
(43) Pub. Date: Oct. 8, 2015

(54) MULTI-MODAL NETWORK AND METHOD FOR DISTRIBUTING RESOURCES IN A MULTI-MODAL NETWORK

(71) Applicant: SIEMENS AKTIENGESELLSCHAFT, München (DE)

(72) Inventors: Silvio Becher, Munich (DE); Michael Metzger, Markt Schwaben (DE); Jochen Schäfer, Nuremberg (DE); Rudolf Sollacher, Eching (DE)

(73) Assignee: SIEMENS AKTIENGESELLSCHAFT, München (DE)

(21) Appl. No.: 14/646,201

(22) PCT Filed: Sep. 20, 2013
(86) PCT No.: PCT/EP2013/069552

§ 371 Date: May 20, 2015

(30) Foreign Application Priority Data
Nov. 21, 2012 (DE) 10 2012 221 291.4

(51) Int. Cl. G06Q 10/06; G06Q 50/06; G06Q 30/06

(52) U.S. Cl. CPC G06Q 10/06313; G06Q 30/0613; G06Q 50/06

(57) ABSTRACT

A network with a plurality of subnetworks has at least two subnetworks each distributing different resources. The resources of each of the subnetworks are selected from fossil fuel, electrical energy, water, heat and cold. The subnetworks have a plurality of resource processing units, at least a portion of which are transforming units that couple the subnetworks together and transform the resources of one or more subnetworks into one or more other resources of one or more other subnetworks. At least a portion of the resource processing units are resource consumption units and/or resource provision units. At least one agent is assigned to each of the resource processing units and the agents are networked together in such a manner that each agent is able to communicate with other agents in the network. The resources are distributed in the network at least partially based on monetary transactions negotiated between the agents.

### CROSS REFERENCE TO RELATED APPLICATIONS

This application is the U.S. national stage of International Application No. PCT/EP2013/069552, filed Sep. 20, 2013 and claims the benefit thereof. The International Application claims the benefit of German Application No. 102012221291.4 filed on Nov. 21, 2012, both applications are incorporated by reference herein in their entirety.

### BACKGROUND

Described below is a multi-modal network for distributing resources and a method for distributing resources in such a multi-modal network.

Multi-modal networks have a plurality of subnetworks which distribute different resources in the form of fossil fuel, electrical energy, water, heat and cold using resource processing units. In this case, the subnetworks are coupled to one another via conversion units which convert the different resources of the subnetworks into one another In this case, no mechanisms have been known to date in terms of how the resources can be distributed in a multi-modal network across the subnetworks in a simple and efficient manner.

### SUMMARY

It is desirable to provide a multi-modal network which meets the above requirements.

The multi-modal network described below has a plurality of subnetworks, at least two subnetworks distributing different resources and the resource of a respective subnetwork being selected from fossil fuel, electrical energy, water, heat and cold. The subnetworks include a plurality of resource processing units, at least some of the resource processing units being conversion units which couple the subnetworks to one another and convert the resources of one or more subnetworks into one or more other resources of one or more other subnetworks. The conversion units are therefore units which belong to at least two subnetworks. Furthermore, at least some of the resource processing units are resource consumption and/or resource provision units. In this case, a resource processing unit may possibly be a combination of a conversion unit and a resource consumption and/or resource provision unit. At least one agent is respectively assigned to the resource processing units, the agents being networked to one another in such a manner that each agent can communicate with other agents in the network. In this case, the network described below is configured in such a manner that the resources are distributed in the network at least partially on the basis of monetary transactions negotiated between the agents.

According to the method described below, each change in the resource delivery or resource consumption presupposes a trade action, thus avoiding large balance errors. In order to make this coupling between resource delivery or resource consumption and a monetary action feasible, a wide variety of contracts can be concluded between resource processing units.

The method therefore suitably distributes resources on the basis of market mechanisms of supply and demand for resources. In this case, the monetary transactions are, in particular, contracts which are negotiated between individual agents and are used to stipulate the sale or purchase of particular quantities of resources. These contracts therefore also determine the price at which the resource is sold by one agent and is purchased by the other agent.

According to the method described below, the distribution of resources is controlled in a self-organizing manner by virtue of the agents providing the functionality of negotiating monetary transactions. This easily achieves self-organizing distribution of different resources which is controlled in a decentralized manner in a multi-modal network.

In one embodiment, the subnetworks include an electrical energy network and/or a water distribution network and/or a gas distribution network and/or a district heating network and/or a district cooling network. Furthermore, in another embodiment, at least some of the resource processing units and, in particular, at least some of the conversion units have one or more resource stores. This makes it possible to temporarily store resources which have been obtained or are to be provided.

In another embodiment, at least one conversion unit include a combined heat and power plant for converting the resource of fossil fuel, and in particular gas, into the resources of heat and electrical energy. At least one conversion unit may likewise include a cold compression unit for converting the resource of fossil fuel and/or electrical energy into the resource of cold.

In another embodiment, at least one conversion unit includes a water treatment unit for treating water (for example seawater) using electrical energy and/or heat and/or a fossil fuel to produce treated water and, in particular, drinking water, the water treatment unit may have a store for storing water from a water distribution network. The water treatment unit therefore couples one or more subnetworks which distribute the resources of electrical energy and/or heat and/or fossil fuel to a subnetwork which distributes (already treated) water and, in particular, drinking water. In this variant, a decision may be made on the basis of the prices of drinking water or electrical energy and/or heat and/or fossil fuel as to whether water is obtained from the water distribution network or is produced using the water treatment installation. The variant which is more favorable in terms of price is generally selected.

In one advantageous refinement of the network, the respective agent of one or more of the conversion units controls the conversion of one or more resources into one or more other resources on the basis of one or more optimization criteria, the optimization criterion or criteria into account variable prices of the resources involved in the conversion. The optimization criterion or criteria may be the highest possible monetary profit for the corresponding conversion unit as the criterion.

In order to perform the above monetary transactions, each agent in the network may include a transaction unit which automatically negotiates prices for providing and/or obtaining resources with other agents and concludes corresponding contracts. An agent assigned to a respective resource processing unit also may be a resource measuring and/or resource control unit for measuring and/or controlling the resources converted and/or consumed and/or provided by the respective resource processing unit in order to thereby determine whether and how many resources can be offered for sale in the network or should be acquired by purchase.

Each agent may have one or more communication interfaces, in particular an external communication interface for communicating with other agents and/or an internal communication interface for communicating with the resource processing unit(s) to which the respective agent is assigned.

In order to make it possible for a user to easily access the agent's settings, each agent includes, in one embodiment, one or more user interfaces for accessing and setting parameters of the respective agent.

In another refinement of the method, the parameters of an agent can be checked in a particularly simple manner by virtue of the fact that a respective agent automatically generates reports relating to its state. These reports can then be viewed by a user, for example via corresponding user interfaces.

In one embodiment, the negotiation of the monetary transactions is controlled by a central unit in each subnetwork. This is a local resource balance unit which may be configured in such a manner that it collects offers and requests by the agents for the resource of the respective subnetwork and facilitates purchases and sales of resources between the agents on the basis of the offers and requests. This creates a central trading platform in the manner of a stock exchange on which the resource in the respective subnetwork is traded as a commodity. The resources in the respective subnetwork are therefore suitably distributed in a simple manner by market mechanisms.

In order to carry out the greatest possible number of transactions at a particular time in the energy network, the resource balance unit is configured, in one embodiment, in such a manner that it calculates a resource price for the resource of the respective subnetwork, for which the greatest number of monetary transactions takes place between the agents of the respective subnetwork. This price is referred to as the market clearing price, the calculation of which is explained in more detail in the detailed description. The resource balance unit then facilitates the purchases and sales of energy on the basis of this resource price.

The resource balance unit also may be configured in such a manner that the agents of the respective subnetwork can access the unit in order to view the transactions facilitated by the resource balance unit. In order to possibly also perform transactions outside the respective subnetwork, the resource balance unit is configured, in another refinement, in such a manner that it can contact the resource balance units of other subnetworks in order to provide the other subnetworks with resources or to obtain resources from the other subnetworks.

In order to avoid misuse when performing transactions for distributing resources and when performing monetary transactions, a monitoring unit is also provided in the network in one embodiment. This unit monitors the performance of the monetary transactions and the provision and consumption and conversion of resources by the resource processing units on the basis thereof. In this case, the monitoring unit is authorized to initiate countermeasures if predetermined criteria are present. Such criteria are, in particular, detected misuse or emergency situations. In the event of a shortage of resources for example, it must be ensured that the resources which are still available (for example electrical energy) are first of all distributed to public units, for example hospitals, before they are made available to other industrial installations.

In one embodiment, the countermeasures which can be carried out by the monitoring unit include reducing and/or increasing the resource provided and/or consumed and/or converted by a respective resource processing unit and/or outputting a corresponding command to reduce and/or increase the resource provided and/or consumed and/or converted by a respective resource processing unit; in particular, the countermeasure may also include the complete disconnection of a respective resource processing unit.

In another embodiment, the agents each have electronic seals for avoiding manipulation of the agents, where the monitoring unit may be authorized in this case to check the electronic seals of the agents. In addition, in one embodiment, the monitoring unit is authorized to receive indications of presumed misuse and to carry out and/or initiate investigations relating to presumed misuse.

In another refinement, each subnetwork also includes a management unit for managing the resource processing units belonging to the respective subnetwork and their agents. In this case, the management unit may be configured in such a manner that it registers and/or unregisters agents in the respective subnetwork. In this manner, the management unit stores how many and which resource processing units are involved in the respective subnetwork. In particular, the management unit is configured in such a manner that it provides information relating to the respective subnetwork via an interface, in particular a website, and makes it possible to register and/or unregister agents.

A task of the management unit may be to monitor the resource consumption and the resource generation and the resource conversion by the resource processing units, in which case it determines countermeasures if resource bottlenecks and/or equipment bottlenecks (that is to say bottlenecks other than the resource which are needed to operate the resource processing unit) and/or imbalances in the resource distribution occur and outputs corresponding instructions and/or proposals to the agents of the respective subnetwork. The countermeasures may include, in particular, decoupling the energy network from other energy networks and outputting instructions to the agents in order to increase the resource generation and/or reduce the resource consumption and/or change the conversion of the resources by the resource processing units belonging to the respective agents. The management unit may also possibly perform analysis of the resource distribution in the respective subnetwork, corresponding statistics being able to be generated, for example, for subsequent evaluation on the basis of the analysis.

In another refinement, the management unit may provide advisory services and/or services for promoting the technical further development of the network or the respective subnetwork. The advisory services may involve, for example, being able to access a website on which appropriate information for advising the network subscribers can be retrieved. A service for promoting the technical further development may involve using the management unit to define programs which prompt the subscribers in the network, for example using monetary rewards, to develop better algorithms (for example for quickly decoupling a subnetwork) and to make them available to the management unit.

In another refinement, the management unit of a respective subnetwork establishes an interface to other subnetworks, that is to say the management unit is configured in such a manner that it can communicate with other subnetworks, in particular with management units of other subnetworks.

In addition to the multi-modal network described above, a method is described below for distributing resources in such a network, in which case the resources are distributed in the network at least partially on the basis of monetary transactions negotiated between the agents.

### BRIEF DESCRIPTION OF THE DRAWINGS

These and other aspects and advantages will become more apparent and more readily appreciated from the following description of the exemplary embodiments as described in detail below using the accompanying figures, in which:

FIG. 1 is a schematic network diagram of one embodiment of a multi-modal network; and

FIG. 2 is a schematic block diagram representing the structure of a conversion unit from the network in FIG. 1.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

One embodiment of a multi-modal network which distributes resources on the basis of the principles of self-organization and decentralization is described below. The network includes a first subnetwork SN1 which is an energy network which distributes electrical energy as the resource. A second subnetwork SN2 which distributes a different resource is also provided, the resource being natural gas in the embodiment described here, that is to say the second subnetwork SN2 is a gas distribution network. Both subnetworks have a plurality of individual agents PAs (PA=private agent) which are each assigned to a resource processing unit. The term of the PA is generally also used as a synonym for the associated resource processing unit below. In both subnetworks, resource consumption and/or resource provision units and resource conversion units are provided as resource processing units. By way of example, one resource conversion unit with a combined heat and power plant contained therein is indicated using the reference symbol TU. This unit belongs both to the subnetwork SN1 and to the subnetwork SN2 and therefore couples both subnetworks.

The resource provision and/or resource consumption units in the subnetwork SN1 are electrical energy generation and/or energy consumption units. In this case, the energy generation units are, for example, photovoltaic installations, wind turbines, Stirling engines and so-called CHP (CHP=combined heat and power) installations. The CHP installations may generate energy, for example, on the basis of the combustion of diesel or on the basis of the combustion of hydrogen or hydrocarbons in fuel cells. The energy consumption units are, in particular, private households, commercial consumers (such as office buildings, public baths and the like) and industrial consumers. The energy consumption or energy generation units may possibly be combined units which can both consume energy and provide (surplus) generated energy in the network. The resource provision and/or resource consumption units in the subnetwork SN2 are gas generation units and/or gas consumption units and/or gas distribution nodes.

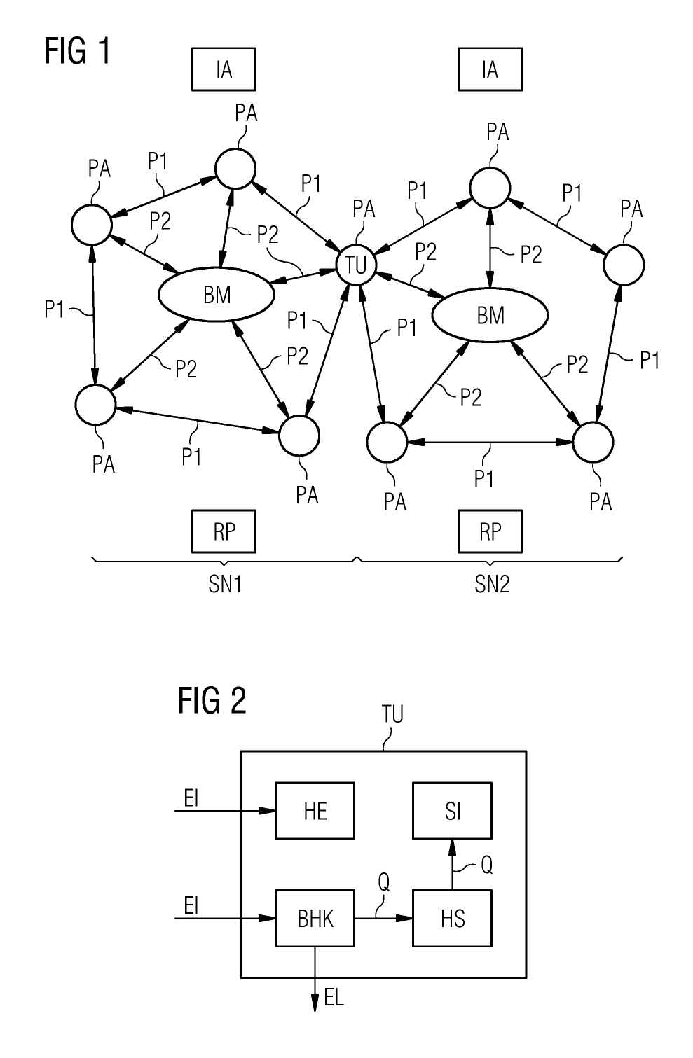

The network shown in FIG. 1 distributes the provided and consumed resources as uniformly as possible within the respective subnetworks, surplus resources of one subnetwork possibly also being able to be made available to other networks by conversion in corresponding conversion units and resources being able to be obtained from other networks via the conversion units.

In both subnetworks SN1 and SN2, the agents PA can communicate with one another, which is indicated by the arrows P1. In this case, the agents can also communicate across the networks using the agent assigned to the conversion unit TU. Resource balance units BM (BM=balance master) are also provided in each of the two subnetworks and can be used by the agents of the respective subnetwork to communicate, as indicated by the arrows P2. Each subnetwork also contains a so-called administration unit IA (IA=island administration) and a monitoring unit RP (RP=resource police). The function of the individual components of the subnetworks is described in more detail further below.

FIG. 2 indicates the structure of the conversion unit TU from the network in FIG. 1. As the resource or incoming energy EI, the conversion unit processes natural gas which comes from the subnetwork SN2. The incoming energy is converted into heat Q and electrical energy EL by combustion in a combined heat and power plant BHK. Optionally, an additional heating unit HE may also be provided, which heating unit converts natural gas into additional heat by combustion for local use in the conversion unit. The electrical energy EL generated in the combined heat and power plant BHK is supplied to the electrical energy network SN1. The combined heat and power plant also generates, as a further resource, heat Q which is supplied to a heat store HS, from which the heat can then be removed by a heat sink SI. In this case, the heat sink may be a local heat sink in the conversion unit. The heat Q from the heat store may possibly also be supplied to a heat sink in the form of a district heating network which constitutes another embodiment of a subnetwork as described herein.

As indicated in FIG. 1, an agent PA is assigned to the conversion unit TU. The agent performs monetary transactions for the purpose of obtaining natural gas from the subnetwork SN2 or providing electrical energy in the subnetwork SN1 and possibly providing heat in a further subnetwork. In this case, the conversion of the resource of natural gas into the resource of electrical energy and possibly heat may be controlled on the basis of an optimization method in order to maximize the monetary profit when selling electrical energy and possibly heat, for example. The prices for natural gas, electrical current and possibly heat are included in this case in the optimization method as variables which can change. The optimization method described in the article by P. Wolfrum, M. Kautz, J. Schafer, “Smart Operation of CHP Units”, 8th Power Plant & Power System Control Symposium 2012, Sep. 2-5, 2012, Toulouse, can be used, for example, to control the conversion unit.

The functions of the components contained in the energy network SN1 are explained below using the example of the energy network. These functions can also be analogously applied to the subnetwork SN2 and further subnetworks, wherein the term of the electrical energy must be replaced with the term of the corresponding resource (that is to say with the term natural gas for the subnetwork SN2) in this case.

The energy network SN1 shown in FIG. 1 distributes the generated or consumed energy as uniformly as possible within the subnetwork, surplus energy also possibly being able to be made available to other subnetworks and energy also being able to be obtained from other subnetworks in the event of energy bottlenecks. In this case, the boundary conditions of this self-organizing energy distribution are, on the one hand, that the voltage and the frequency of the electrical energy provided are intended to be kept constant and, on the other hand, that it is intended to be possible to operate the subnetwork autonomously, that is to say independently of other subnetworks. In order to achieve this, the PAs are networked to one another in such a manner that each PA can communicate, that is to say can interchange corresponding information, with another PA. In addition, a central local resource balance unit BM which can be accessed by each PA is also provided. In this case, the communication between the PAs is indicated using corresponding arrows P1, whereas the communication between the individual PAs and the resource balance unit BM is represented using corresponding arrows P2. In this case, the communication between the PAs is not restricted to adjacent PAs, but rather each PA can communicate with each PA.

The energy in the energy network in FIG. 1 is distributed substantially in a market-based manner by virtue of the individual PAs providing their required or surplus energy as a commodity between one another or with the interposition of the local resource balance unit BM and performing monetary transactions on the basis thereof. The local resource balance unit BM therefore substantially constitutes a facilitation unit for the supply and demand of the individual PAs which purchase and sell energy for money. Since purely market-controlled distribution of the energy in the event of emergencies or misuse by the PAs may result in a severe imbalance in the energy distribution under certain circumstances, an administration unit IA (IA=island administration) and a monitoring unit RP (RP=resource police) are also provided in the embodiment in FIG. 1 and, in the event of emergencies or misuse, provide energy distribution control mechanisms which intervene in the purely market-based distribution of the energy. The management unit IA and the monitoring unit RP may be public institutions in this case which have been stipulated by the PAs belonging to the energy network in order to perform tasks which cannot be optimally controlled by pure market regulation mechanisms, for example monitoring the legal admissibility of a trade action for purchasing or selling energy or decoupling the energy network illustrated in FIG. 1 from other networks.

The tasks and functions of the individual components of the energy network SN1, that is to say the agents PAs, the resource balance unit BM, the management unit IA and the monitoring unit RP, are described in detail below.

As already mentioned, the PAs negotiate monetary transactions for providing or obtaining energy either between one another or with the interposition of the resource balance unit BM. In this case, the PAs may be assigned to any desired energy generation or energy consumption units or conversion units, the PAs being divided into three classes, for example. The first class relates to micro PAs which are assigned to energy consumption and/or energy generation units with a consumption or generator power of 5 kW and less. The second class relates to mini PAs which are assigned to energy consumption and/or energy generation units with a consumption or generator power of 30 kW and less. The third class includes industrial PAs which are assigned to energy consumption and/or energy generation units with a consumption or generator power of 30 kW and more. The most important functions of a respective PA may be divided into a total of seven function classes which are as follows:
measuring functions,
functions for controlling the flow of energy,
user interface functions,
internal communication,
external communication,
reporting functions,
financial functions.

In this case, only some of the functions may possibly be implemented in one PA. According to the measuring functions, the temporally resolved flow of the total energy and the flow of the energy for specific loads and generators are monitored and stored. Furthermore, statistical functions are implemented and calculate the average energy curve (load curve, energy generation curve) for an “average day” or an “average week”. In addition, the measuring functions provide energy quality functions which monitor the quality of the provided frequency, voltage and the like.

The functions of the PA for controlling the flow of energy make it possible for a user of the PA to parameterize particular prescribed load curves which are intended to be complied with in the PA. In addition, the user can program particular reaction mechanisms which stipulate how the PA is intended to react to significant deviations from a predetermined energy consumption behavior. If the PA has its own energy generators (for example wind generators, biomass generators and the like), the PA controls the balance between internal and external energy generation and energy consumption. In addition, a PA has different energy reduction or energy disconnection scenarios which are carried out by the PA if necessary and which can be externally initiated, for example, by the administration unit IA or the monitoring unit RP. These scenarios may be individually programmed if necessary.

The user interface functions of a PA are implemented, for example, by an internal web server which makes it possible to parameterize the PA with the aid of a computer, in particular a commercially available PC. The access to the PA from the outside is also controlled with the aid of the user interface functions. In particular, the parameterization of the PA can be delegated to a service provider providing the management of the PA as a service. The user interface functions also include alarm mechanisms which can be programmed to inform a user of the PA when significant deviations from a predetermined load behavior occur, which deviations result in very high energy costs, for example, on account of a deviation from a predefined contract. The alarm can be implemented acoustically, optically, by sending an SMS or email or in any other desired manner.

On the basis of the function of internal communication, a PA communicates with internal generators and loads via a standardized interface which is used by the PA to output commands to connect a generator, for example. In addition, the PA can communicate with so-called “intelligent” loads in order to reduce its power. For example, such an intelligent load may be a cooker which prevents a user from switching on a further hotplate if a hotplate is already active. Intelligent loads may also be implemented in the form of an intelligent household, intelligent building management or in the form of small-sized and medium-sized intelligent industrial installations.

On the basis of the function of external communication, a respective PA communicates with the resource balance unit BM in order to conclude a corresponding contract for purchasing or selling energy. In addition, the external communication can also take place directly between individual PAs. Furthermore, each PA has a communication interface to the management unit IA (described further below) in order to receive an instruction to reduce the load, for example. Each PA also communicates with the monitoring unit RP which is described in yet more detail further below. Corresponding security functions are also implemented using the function of external communication.

According to the reporting functions, a PA generates reports relating to the generation and consumption of energy, reports relating to individual events, reports relating to financial statistics and reports containing proposals for optimizing the PA (for example recalibration of the load curve, flexible handling of the negotiation of contracts and the like).

According to the financial functions, a respective PA negotiates with other PAs in order to purchase correspondingly required energy or to sell surplus energy. The energy is therefore a commodity, with this commodity, for example, being traded via the resource balance unit BM. A further function of the PA is to autonomously implement energy contracts through the mediation of the resource balance unit BM or directly with other PAs. In addition, a PA may use optimization algorithms in order to reduce the costs for purchasing energy and to maximize the income when selling energy. Further optimization mechanisms are optionally also provided when negotiating the contracts. The financial functions also include an electronic seal, which seals safeguard the data relevant to the monetary trade actions, with the result that a user cannot manipulate them. In addition, security functions are implemented in order to protect the data on the PAs and to prevent them from being spied out.

As mentioned above, a PA is intended to autonomously implement energy contracts, in particular. This means that a PA should trade autonomously in most cases. Under certain general rules which are predefined by the user of the PA, the PA is intended to be able to implement standard situations for negotiating monetary transactions relating to the purchase and sale of energy.

If such standard situations deviate from predefined profiles under certain conditions, the user is informed of this and can manually intervene. In order to also add yet further intelligent functionalities at a later time in addition to the elementary functionalities of a PA, a generic platform should be used to implement the PA.

A PA can be implemented in a similar manner to a DSL router, in which case an open-source operating system may be used to operate the PA, for example Linux. In this case, a standard user uses only the standard functionalities of the router. Users with more experience can implement and dynamically adapt further functions on the basis of the open-source operating system.

In order to implement an energy network SN1 according to FIG. 1, it is necessary for the operators/users of individual energy consumption or energy generation units to be prepared to purchase a corresponding PA. This is achieved, in particular, when the energy generators cause the energy consumers to use a PA by providing reduced-price energy tariffs if a PA is used by a consumer. In this case, the price for purchasing a PA should be in a ratio of 1:1 to 2:1 with respect to the annual energy consumption costs.

The user interface functionality of the PA should be sufficiently complex to ensure reporting functionalities, control functionalities and the like. Therefore, a large screen is obligatory. Since this possibly results in a no longer acceptable price for the PA, the possibility of the PA being able to be connected to a commercially available PC should also exist, in particular. The PA should therefore be implemented as a web server.

The functionalities of the resource balance unit BM are described below. A fundamental idea on which the use of a BM is based is that an energy consumption or energy generation action is assigned to each trade action. In this case, the PA is an agent trading on behalf of the corresponding consumer or generator to which the PA is assigned. In addition to local functions relating to the measurement and control of the local supply and demand for energy, a BM should also be able to act outside the market assigned to the local energy network in order to purchase or sell energy. However, the main task of the BM is to provide a platform for the local market of the individual PAs of the energy network in FIG. 1. In this case, the BM may be implemented as a web server which can be accessed by the PAs using standardized protocols. The most important functions of the BM are as follows:
collecting offers and requests,
calculating a so-called market clearing price,
implementing contracts,
displaying trading activities on a website,
negotiating with other and larger BMs in order to take into account an oversupply or undersupply of energy,
reporting to energy generators and energy consumers.

In this case, only some of the functions may possibly be implemented in one BM.

In order to implement the functionality of collecting offers and requests, a standardized interface is provided and is used by the PAs to contact the BM. They can request the current market clearing price and can make offers relating to the purchase and sale of energy and can request the current status of trade actions.

According to the functionality of calculating the market clearing price, the BM calculates that price which results in the greatest number of monetary transactions for purchasing or selling energy according to the supply and demand for energy. In this case, this market clearing price is determined as follows:

It is assumed that a total of Nᵢ PAs would purchase a total amount of nᵢ electricity (in kWh) at a price of pᵢ at a given time t. These PAs would naturally also purchase the same amount of energy/electricity at a lower price. Therefore, a total amount of electricity would be purchased at a predefined price pₖ, as follows:

$${E}_{{p}_{k}} = {\sum }_{i = k}^{∞} {n}_{i} .$$

In this case, all prices which are greater than pₖ are added, that is to say the prices are organized as follows:

pᵢ₋₁<pᵢ<pᵢ₊₁.

Conversely, a number Aⱼ of PAs would sell a total amount of electricity aⱼ at a price pⱼ or higher at a given time t. The total amount of energy which is finally sold at a price pₖ is then as follows:

$${E}_{{p}_{l}} = {\sum }_{j = 0}^{k} {a}_{j} .$$

The market clearing price p_{NCP} at which the largest number of transactions is carried out can finally be calculated from these aggregated offers and requests. If a continuous representation of the price is assumed, this market clearing price results if the following condition is met:

$${\int }_{{p}_{MCP}}^{∞} n ( p ) d p = {\int }_{0}^{{p}_{MCP}} a ( p ) d p .$$

This market clearing price is calculated by the BM and the monetary transactions are then facilitated between the individual PAs on the basis of this price.

So that the BM can implement the corresponding monetary transactions, the BM itself has a broker function, that is to say each PA can directly access the BM without a further trader being interposed. The BM should therefore have banking rights and should be able to conclude the corresponding sales contracts and be able to manage the bank accounts of the PAs. Optionally, a BM may also be implemented as an inter-regional resource balance unit in order to make it possible to interchange energy between individual local energy networks or subnetworks. For this purpose, an intermediate layer may possibly be provided between the PA and the BM in the form of an energy trader.

In order to make trading activities visible to PAs, such activities are represented on a website which can be visited by the individual consumers or energy generators. This site may therefore be a platform in order to encourage new market developments, inform the consumers and communicate trends and estimates to the consumers.

A BM may also contact other or larger BMs under certain circumstances, in particular if there is a local need for energy or there is a local surplus of energy. The BM can then offer the surplus energy to other BMs or can purchase energy from other BMs. The BM therefore facilitates contracts between contractual partners remote from one another.

The above-mentioned reporting functionality of the BM is particularly important since the PAs operate very autonomously. This is due to the fact that a user often desires a high degree of automation for a commodity such as electricity. On the basis of the reporting functionality, a user can then check which quantities of energy have been purchased by whom and what prices have been paid for the energy.

The BM may also have a security functionality. This security functionality should correspond to the security requirements of the PAs since the BM is a communication partner of the PAs.

The functionalities of the monitoring unit in the form of the resource police RP are explained below. In this case, it should be taken into account that a difference between electrical energy as a commodity and other commodities is that electrical energy cannot be distinguished. The seller of electricity cannot provide the transmitted quantity of electricity with corresponding identifications which clearly indicate the origin of the energy. There is therefore no interposed entity which can track the transmission of an energy package. Rather, each seller puts the sold amount of energy generated thereby in a common pool and the consumer takes a corresponding amount of energy from the pool according to the certificate with which the consumer purchased the amount of energy. Substantially two different types of possible fraud therefore occur:
The seller sells energy which has not been put into the pool thereby.
The consumer takes energy from the pool for which the consumer has not paid.

There is therefore the need for a control entity which is authorized to check the legality of trade actions and is also authorized to intervene in the event of corresponding fraud. This institution is the monitoring unit RP shown in FIG. 1. This monitoring unit can be implemented as a web server, for example. The fundamental functionalities of this unit are as follows:
monitoring trade actions,
checking that contracts are complied with,
carrying out measurements in order to track energy bottlenecks,
access right to the PAs,
checking the integrity of the electronic seal of a PA,
authorization to instruct disconnection or a reduction in the power of an energy generator or an energy consumer,
authorization to force disconnection or a reduction in the power of an energy generator or an energy consumer,
receiving indications with regard to presumed misuse,
carrying out investigations relating to presumed misuse.

In this case, only some of the functionalities may possibly be implemented in one RP.

The functionality of monitoring the trade actions ensures the legality of each trade action. This is effected by virtue of the fact that each trade action is reported to the monitoring unit, the report including the traded amount of energy and the time of production or consumption. The monitoring unit inserts this trade action into an overall timing scheme. When the time of implementing the trade action has been reached, the monitoring unit carries There is therefore the need for a control entity which is authorized to check the legality of trade actions and is also authorized to intervene in the event of corresponding fraud. This institution is the monitoring unit RP shown in FIG. 1. This monitoring unit can be implemented as a web server, for example. The fundamental functionalities of this unit are as follows:
monitoring trade actions,
checking that contracts are complied with,
carrying out measurements in order to track energy bottlenecks,
access right to the PAs,
checking the integrity of the electronic seal of a PA,
authorization to instruct disconnection or a reduction in the power of an energy generator or an energy consumer,
authorization to force disconnection or a reduction in the power of an energy generator or an energy consumer,
receiving indications with regard to presumed misuse,
carrying out investigations relating to presumed misuse.

In this case, only some of the functionalities may possibly be implemented in one RP.

The functionality of monitoring the trade actions ensures the legality of each trade action. This is effected by virtue of the fact that each trade action is reported to the monitoring unit, the report including the traded amount of energy and the time of production or consumption. The monitoring unit inserts this trade action into an overall timing scheme. When the time of implementing the trade action has been reached, the monitoring unit carries out measurements both of the energy generation and of the energy consumption in order to check whether the trade action has been correctly carried out.

The functionality of carrying out measurements in order to track energy bottlenecks is used to determine those energy bottlenecks whose cause is not based on misuse. Such energy bottlenecks may be caused, for example, by incorrect calibration of measuring devices, losses on the lines and the like. Accurate measurements at different locations, in particular at energy installations for balancing the energy, are the basis for accurately checking the system and detecting any type of technical problems.

According to the functionality of access to the PAs, the monitoring unit has the exclusive right to access the PAs with or without corresponding court orders on the basis of the respective situation. In order to monitor trade actions, there is standard access to the respective PA. This access is protected by a cryptographic mechanism, with the result that only the monitoring unit can access these data.

According to the functionality of checking the electronic seal of a PA, it is possible for the monitoring unit to access the PA in order to check the integrity of this seal. In this case, the seal protects that data area of the PA which contains trade-related information.

Since the monitoring unit carries out a multiplicity of measurements, it can quickly detect problems in the provision of or demand for electrical energy. In order to pre-empt damage relating to relatively large public institutions such as hospitals, public facilities and the like, the monitoring unit has the functionality of ordering disconnection or a reduction in the power of energy consumers or energy generators. In this case, the PAs implement mechanisms as regards the response to such commands. Such a command may define time delays, may be tied to conditions and may be prioritized.

In emergencies in which damage is intended to be avoided, the monitoring unit may also output a command which is not tied to a condition. This command controls, inter alia, increasing the power or increasing or reducing the power in a differentiated manner or disconnecting the power of individual consumers or energy generators. For example, the disconnection of televisions may be enforced since a heavy electrical device must remove a tree from railway tracks.

According to another functionality, the monitoring unit is also used to receive indications relating to presumed fraud.

In the case of presumed fraud in the energy network itself, the monitoring unit may also be authorized to carry out investigations. The investigations may be initiated by web robots, for example. Furthermore, the management unit may also be used only to initialize investigations, the investigations themselves being carried out by human users.

Various security aspects need to be heeded when implementing the monitoring unit in order to implement the functionality of a police entity. These aspects relate, inter alia, to the detectability of fraud, that is to say it is necessary to indicate that an agent in the network which has carried out a particular action cannot dispute the ownership for this action.

The functionalities of the management unit IA shown in FIG. 1 are explained below. According to the energy network illustrated in FIG. 1, the PAs involved therein form a type of “island” which is managed using the management unit IA. The meaning of such an island is that, in the case of problems caused by remote locations of the island, the “inhabitants of the island” (representing the PAs) have the option of being decoupled from the “rest of the world” and solving their energy problems themselves. Such a remote cause may be, for example, the disconnection of a high-voltage line in another country. The option of decoupling implies that the capacities of energy generation and energy demand on the island are balanced. The principle of the island is “self-similar”, that is to say islands of any possible power class down to an individual household can be implemented. If each household or at least a relatively large part of a household has a type of energy generation (for example a photovoltaic roof), it is possible to operate the island on this very small scale at least for a particular time.

The management unit IA is a unit which undertakes administrative tasks for each island of PAs and implements the required administrative structures. In particular, such a management unit has the following functions:
registering and unregistering PAs with the management unit,
managing a website containing information relating to the island,
decoupling the island,
monitoring power imbalances,
advisory services, analysis,
technical development of the island,
communication with other islands.

In this case, only some of the functions may optionally be implemented in one IA.

According to the registering or unregistering functionality, a new consumer can register with a management unit. A plurality of management units may possibly be active in a predefined geographical area. The advantage of registering with a management unit is that, in the case of a remote power failure, the individual, registered unit is embedded in a larger context, with the result that operation of the unit is suitably ensured after such an event. Competition between individual management units is naturally desired and there is therefore also the possibility for the PAs to unregister from a management unit.

The management unit uses a website to provide information relating to the number and capacities of the energy consumers or energy generators belonging to an island. The website also allows access to the registration process. In addition, information relating to the rules predefined for the island is given, for example which actions are carried out if an island is decoupled, how the management unit deals with the market-based energy distribution and the like.

The process of decoupling the island is initialized, by the management unit, in particular when a remote power failure occurs which influences the energy supply to the PAs of the island.

In order to decouple the island, the management unit is authorized to predefine energy controllers for the energy generators and energy consumers. The management unit contains a database of information relating to the flexibility of the different energy generators and energy consumers. This information can be automatically collected in good time by communication between the management unit IA and the PAs. If, for example, the external energy supply reaches a level of 30% and then suddenly completely fails, the management unit instructs the energy consumers to immediately reduce their energy consumption accordingly. The management unit then determines the energy generation capacities inside the island and instructs the energy generators to undertake the accordingly required generation of energy. In principle, such a failure of an external energy supply could also be controlled via the market. However, there is then the risk of industrial installations competing with hospitals with regard to the purchase of energy. It is therefore useful to balance the mechanisms of the free market, which is achieved using the management unit which operates according to generally recognized action plans in the case of emergency situations.

In order to keep the voltage and the frequency in the energy network stable, energy compensation installations are usually present in known energy networks and compensate for poor estimates of power losses, the incorrect performance of contracts, incorrect measurements or the like. Such compensation installations always result in additional losses. In order to reduce the use of such energy compensation installations as far as possible, the management unit tracks irregular energy distributions, for example with the aid of the monitoring unit RP which identifies their causes. The management unit then proposes corresponding measures for eliminating the problem. The management unit also provides advisory services for the individual PAs with respect to energy-related products, energy-saving possibilities and the like.

The management unit also carries out analyses on the basis of the data measured during operation of the energy network. The analyses are used to generate statistics which make it possible to define corresponding measures in order to improve the energy supply situation of the overall network or of individual energy generators and energy consumers.

The management unit may also support the technical development of the energy network by stipulating corresponding programs. This may naturally also be carried out only on the basis of the mechanism of the free market. However, the focus of the technical development is on features which relate only to the management unit, for example the development of better algorithms in order to quickly decouple the energy network.

The management unit also enables communication with other energy networks or subnetworks, thus making it possible to implement corresponding mechanisms involving the cooperation with other networks.

The security requirements imposed on the management unit IA are similar to the security requirements imposed on the monitoring unit RP since, like the monitoring unit, the management unit is a public entity and has certain execution rights. Dangerous actions which can possibly be carried out by the management unit must therefore be prevented, for example the fact that the management unit incorrectly disconnects an industrial installation from the energy network. The management unit may also be the target of attacks by hackers. Therefore, access control in the management unit is an important security requirement.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-31. (canceled)

32. A multi-modal network for distributing resources, comprising:
a plurality of subnetworks, at least two of the subnetworks distributing different resources, a resource of a respective subnetwork being selected from the group consisting of fossil fuel, electrical energy, water, heat and cold,
each subnetwork having a plurality of resource processing units, at least some of the resource processing units being conversion units coupling the subnetworks together and converting at least a first resource of at least a first subnetwork into at least a second resource of at least a second subnetwork,
at least some of the resource processing units being resource consumption and/or resource provision units, and
the resource processing units respectively assigned agents, at least one agent each, the agents networked to one another so that each agent can communicate with other agents in the network, and the network being configured so that the resources are distributed in the network at least partially based on monetary transactions negotiated between the agents.

33. The network as claimed in claim 32, wherein the subnetworks include at least one of an electrical energy network, a water distribution network, a gas distribution network, a district heating network and a district cooling network.

34. The network as claimed in claim 32, wherein at least some of the conversion units have at least one resource store.

35. The network as claimed in claim 32, wherein at least one conversion unit is a combined heat and power plant converting fossil fuel into heat and electrical energy.

36. The network as claimed in claim 32, wherein at least one conversion unit is a cold compression unit converting at least one of fossil fuel and electrical energy into cold.

37. The network as claimed in claim 32, wherein at least one conversion unit is a water treatment unit treating water using at least one of electrical energy, heat and fossil fuel to produce drinking water, the water treatment unit preferably including a storage unit storing water from a water distribution network.

38. The network as claimed in claim 32, wherein a respective agent of at least one of the conversion units controls conversion of at least the first resource into at least the second resource based on at least one optimization criterion, the at least one optimization criterion taking into account variable prices of the resources involved in the conversion.

39. The network as claimed in claim 38, wherein the at least one optimization criterion produces the highest possible monetary profit for a corresponding conversion unit.

40. The network as claimed in claim 32, wherein each agent includes a transaction unit automatically negotiating prices of at least one of providing and obtaining corresponding resources with other agents to establish corresponding contracts.

41. The network as claimed in claim 32, wherein a respective agent assigned to a respective resource processing unit includes at least one of a resource measuring unit and a resource control unit at least one of measuring and controlling the resources at least one of converted, consumed and provided by the respective resource processing unit.

42. The network as claimed in claim 32, wherein each agent has at least one of an external communication interface communicating with other agents and an internal communication interface communicating with at least one resource processing unit to which the agent is assigned.

43. The network as claimed in claim 32, wherein each agent has at least one user interface accessing and setting parameters of the agent.

44. The network as claimed in claim 32, wherein at least one agent automatically generates reports relating to a state of the at least one agent.

45. The network as claimed in claim 32, wherein each subnetwork includes a local resource balance unit accessed by subnetwork agents of the subnetwork to negotiate monetary transactions during operation of the network.

46. The network as claimed in claim 45, wherein the resource balance unit collects offers and requests by respective agents for a respective resource of the respective subnetwork and facilitates purchases and sales of the respective resource between the agents base on the offers and the requests.

47. The network as claimed in claim 45, wherein the resource balance unit calculates a resource price for the respective resource of the respective subnetwork, for which a greatest number of monetary transactions takes place between respective agents of the respective subnetwork, and facilitates purchases and sales of the respective resource based on the resource price.

48. The network as claimed in claim 45, wherein respective agents of the respective subnetwork access the resource balance unit to view the monetary transactions facilitated by the resource balance unit.

49. The network as claimed in claim 45, wherein the resource balance unit of the respective subnetwork contacts resource balance units of other subnetworks to at least one of provide the other subnetworks with resources and obtain resources from the other subnetworks.

50. The network as claimed in claim 32, wherein each subnetwork further includes a monitoring unit which, during operation of the network, monitors performance of the monetary transactions and provision, consumption and conversion of resources by the resource processing units based on thereon and is authorized to access respective agents of the respective subnetwork and to initiate countermeasures if predetermined criteria are present.

51. The network as claimed in claim 50, wherein the countermeasures include at least one of reducing and increasing a respective resource at least one of provided, consumed and converted by a respective resource processing unit and/or outputting a corresponding command to at least one of reduce and increase the respective resource at least one of provided, consumed and converted by the respective resource processing unit.

52. The network as claimed in claim 50, wherein the agents have electronic seals for avoiding manipulation of the agents, and the monitoring unit is also authorized to check the electronic seals of the agents.

53. The network as claimed in claim 50, wherein the monitoring unit is authorized to receive indications of presumed misuse and to at least one of carry out and initiate investigations relating to the presumed misuse.

54. The network as claimed in claim 32, wherein each subnetwork includes a management unit managing the resource processing units belonging to the respective subnetwork and respective agents thereof.

55. The network as claimed in claim 54, wherein the management unit registers and unregisters respective agents in the respective subnetwork.

56. The network as claimed in claim 54, wherein the management unit provides information relating to the respective subnetwork via a website via which respective agents in the respective subnetwork are at least one of registered and unregistered.

57. The network as claimed in claim 54, wherein the management unit monitors resource consumption, resource generation and resource conversion by the resource processing units, determines countermeasures when at least one of bottlenecks of resource and/or equipment and imbalances in resource distribution occur, and outputs corresponding instructions and/or proposals to respective agents of the respective subnetwork.

58. The network as claimed in claim 57, wherein the countermeasures include decoupling the respective subnetwork from other subnetworks and outputting instructions to the respective agents to at least one of increase the resource generation, reduce the resource consumption and change the resource conversion by the resource processing units belonging to the respective agents.

59. The network as claimed in claim 54, wherein the management unit performs analysis of resource distribution in the respective subnetwork.

60. The network as claimed in claim 54, wherein the management unit provides at least one of advisory services and promotional services promoting technical development of the network.

61. The network as claimed in claim 54, wherein the management unit of the respective subnetwork communicates with other management units of other subnetworks.

62. A method for distributing resources in a network having a plurality of subnetworks, each having a plurality of resource processing units, at least some of the resource processing units being resource consumption and/or resource provision units, at least two of the subnetworks distributing different resources, a resource of a respective subnetwork being selected from the group consisting of fossil fuel, electrical energy, water, heat and cold, said method comprising:
converting at least a first resource of at least a first subnetwork into at least a second resource of at least a second subnetwork in conversion units coupling the subnetworks together;
communicating between agents networked together and respectively assigned to the resource processing units with at least one agent each; and
distributing the resources in the network at least partially based on monetary transactions negotiated between the agents.
